(19) United States
(12) Patent Application Publication
(10) Pub. No.: US 2006/0050232 A1
(43) Pub. Date: Mar. 9, 2006

(54) Tinted contact lenses with gradient ring patterns

(76) Inventors: Jerry Dukes, Jacksonville, FL (US); Douglas Clark, Jacksonville, FL (US); Karin D. McCarthy, Ponte Vedra Beach, FL (US); Angie Bowers, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/922,680

(22) Filed: Aug. 19, 2004

(51) Int. Cl. G02C 7/04

(52) U.S. Cl. 351/162

(57) ABSTRACT

The invention provides tinted contact lenses that include a limbal ring that serves to enhance the definition of the wearer's iris along with two or more gradient rings. The lenses of the invention may be used as cosmetic lenses for enhancing or altering an individual's iris.

### FIELD OF THE INVENTION

The invention relates to tinted contact lenses. In particular, the invention provides contact lenses that either enhance or change the color of a lens wearer's iris.

### BACKGROUND OF THE INVENTION

The use of tinted, or colored, contact lenses to either or both alter the natural color of the iris and to mask ophthalmic abnormalities is well known. Typically, these lenses use either or both opaque and translucent colors to change the color of an iris, as for example, from brown to blue. Additionally, tinted lenses have been manufactured that attempt to enhance the color of a dark-eyed person without changing the color of the iris. These lenses are disadvantageous because either the color enhancement is too subtle to be noticed when the lens is on-eye or the enhancement lends an unnatural appearance to the wearer's iris.

### BRIEF DESCRIPTION OF THE DRAWINGS

FIG. 1 is a scanned image of one embodiment of the invention.

FIG. 2 is a scanned image of a second embodiment of the invention.

FIG. 3 is a scanned image of a third embodiment of the invention.

### DETAILED DESCRIPTION OF THE INVENTION AND PREFERRED EMBODIMENTS

The invention provides tinted contact lenses, and methods for their manufacture, that enhance the lens wearer's iris. The lenses of the invention have a pattern that includes a limbal ring that serves to enhance the definition of the wearer's iris resulting in the iris appearing larger to viewer's of the lens wearer. Additionally, the lenses of the invention have additional pattern elements that partially or completely overlie the wearer's iris, which elements form a gradient ring pattern. The lenses of the invention may find greatest utility as cosmetic lenses for enhancing a dark-eyed individual's iris, but also may be used to enhance the iris of a light-eyed lens wearer as well.

In one embodiment, the invention provides a contact lens comprising, consisting essentially of, and consisting of a limbal ring and a gradient ring pattern. Alternatively, the lens comprises, consists essentially of, and consists of a gradient ring pattern.

By “limbal ring” is meant an annular band of color that, when the lens is on-eye and centered, partially or substantially completely overlies the lens wearer's limbal region, or the junction of the sclera with the cornea. Preferably, the limbal ring substantially completely overlies the limbal region. The innermost border, or edge closest to the geometric center of the lens, of the limbal ring may be at a diameter of about 8 mm to about 12 mm, preferably about 9 to about 11 mm, from the lens' geometric center. The ring may be of any suitable width and preferably is about 0.5 to about 2.5 mm in width, more preferably about 0.75 to about 1.25 mm in width.

Adjacent to the limbal ring's innermost edge is a gradient ring pattern. By “gradient ring pattern” is meant two or more concentric rings which increase or decrease in opacity of color as one moves from the innermost edge of the limbal ring towards the lens' center. Preferably, there is a decrease, in opacity, or lightening of the color, as one moves toward the lens' center. The gradient ring pattern completely or partially composes the iris portion of the lens. By “iris portion” is meant that part of the lens that substantially overlies the lens wearer's iris when the lens is on-eye and centered.

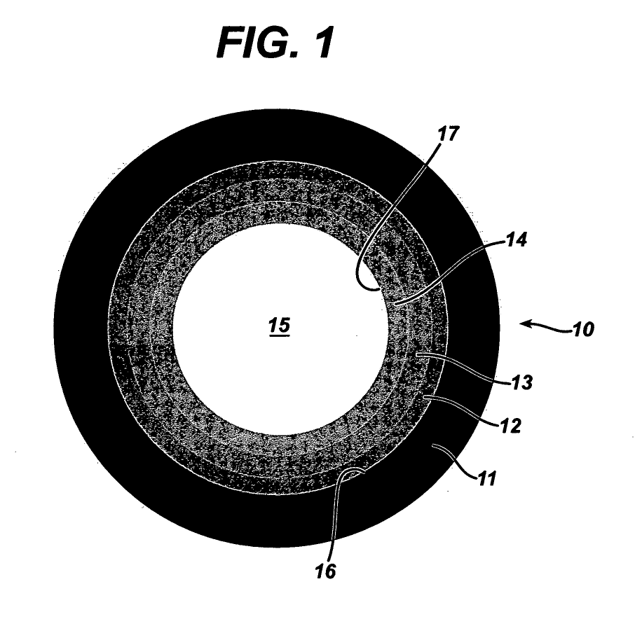

In FIG. 1 is shown limbal ring-gradient ring pattern 10 of the invention. In this embodiment, limbal ring 11 is a black opaque band that is approximately 1 mm in width. Beginning at the innermost border 16 of limbal ring 11 and extending inwardly towards the geometric center of the lens is gradient ring pattern composed of a concentric rings 12, 13, and 14. Each of the gradient rings within the gradient ring pattern may be of any suitable width and preferably are about 0.1 to about 2.00 mm in width. Any number of rings may be used and preferably about 3 to about 6 rings are used. In the design of the invention, the innermost border 17 of the gradient rings may be from about 4 to about 8 mm, preferably about 6.5 to about 8 mm from the lens' geometric center. Area 15 will shown in FIG. 1 will, depending on the location of innermost border 17 composes part of the iris portion as well as the whole of the pupil portion, or only the pupil portion of the lens. By “pupil portion” is meant that portion of the lens which will overlie the wearer's pupil, when the lens is on-eye and centered. As shown and preferably, area 15 is clear. However area 15 may be an area of translucent or opaque color or any combination of opaque and translucent colors.

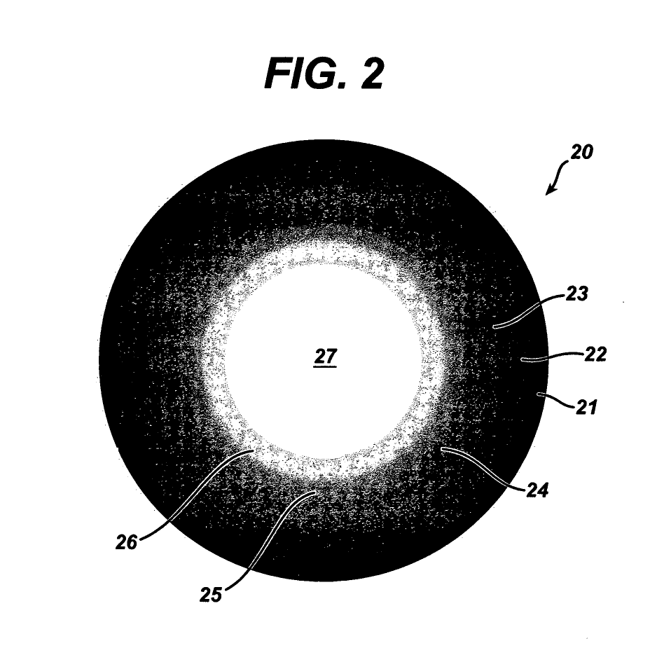

FIG. 2 depicts another embodiment, gradient ring pattern 20. Pattern 20 includes limbal ring 21 and a gradient ring pattern composed of concentric rings 22, 23, 24, 25, and 26. In contrast to FIG. 1, the gradient ring pattern of FIG. 2 is one in which the rings composing the gradient ring pattern are blended at their borders with one another so that one ring smoothly transition into another of the rings. This results in a more uniform appearance of the gradient pattern. In FIG. 2, the bands range in width from about 0.35 mm to about 1.23 mm. Area 27 in FIG. 2 is an area of translucent color.

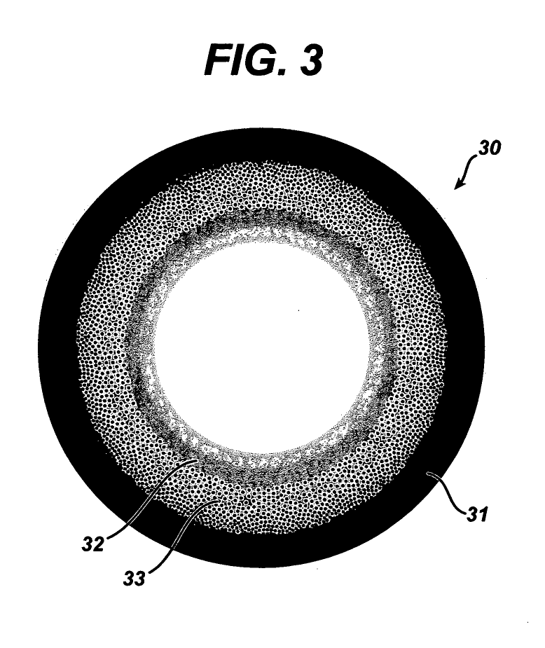

Any number of additional elements may be added to form more elaborate patterns. Such components may include, without limitation, geometric structures, such as dots and lines, or fanciful structures including, without limitation, striae and feather-like structures and combinations thereof. In FIG. 3 is an alternative embodiment depicting a limbal ring 31, gradient rings (only one ring 32 of which is shown) and an area of dots 32. As shown, the dots overlie about 60% of the gradient rings, but may overlie 1 to 90%, preferably 5 to about 75% of the gradient ring pattern. The dots are randomly arranged and may be such that, as one moves inwardly toward the lens' geometric center, the dots become less numerous forming a dot density gradient as shown. The dots may be of any size and preferably are about 0.060 to about 0.180 mm in diameter, more preferably about 0.0075 to about 0.0125 mm in diameter.

As used in a lens for either enhancing or altering the wearer's eye color, preferably the limbal ring element is a solid band of color that masks the color of the lens wearer's limbal region and more preferably the masking color is an opaque color. The color of the limbal ring may be substantially the same as, or complementary to, the color selected for the gradient rings. The additional elements, such as the dots, may be translucent or opaque depending on the desired on-eye result and may be he same color as, or a color complementary to, that of either or both the limbal ring and gradient rings. For purposes of the invention, by “translucent” is meant a color that permits an average light transmittance (% T) in the 380 to 780 nm range of about 60 to about 99%, preferably about 65 to about 85% T. By “opaque” is meant a color that permits an average light transmittance (% T) in the 380 to 780 nm range of 0 to about 55, preferably 7 to about 50% T. The color selected for each of the limbal ring, gradient rings and any additional pattern elements will be determined by the natural color of the lens wearer's iris and the enhancement or color change desired. Thus, elements may be any color including, without limitation, any of a variety of hues and chromas of blue, green, gray, brown, black yellow, red, or combinations thereof. Preferred colors for the limbal ring include, without limitation, any of the various hues and chromas of black, brown and gray.

The elements of the patterns of the invention may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange # 1, and the like and combinations thereof. Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a pre-polymer, or binding polymer, and a solvent to form the colorant used to produce the translucent and opaque layers used in the lenses of the invention. Other additives useful in contact lens colorants also may be used. The binding polymers, solvents, and other additives useful in the color layers of the invention are known and either commercially available or methods for their making are known.

The elements may be applied to, or printed on, one or more surfaces of a lens or may be printed onto one or more surfaces of a mold into which a lens forming material will be deposited and cured. In a preferred method for forming lenses incorporating the designs of the invention, a thermoplastic optical mold, made from any suitable material including, without limitation, cyclic polyolefins and polyolefins such as polypropylene or polystyrene resin is used. The elements are deposited onto the desired portion of the molding surface of the mold. By “molding surface” is meant the surface of a mold or mold half used to form a surface of a lens. Preferably, the deposition is carried out by pad printing as follows.

A metal plate, preferably made from steel and more preferably from stainless steel, is covered with a photo resist material that is capable of becoming water insoluble once cured. The elements are selected or designed and then reduced to the desired size using any of a number of techniques such as photographic techniques, placed over the metal plate, and the photo resist material is cured.

The plate is subsequently washed with an aqueous solution and the resulting image is etched into the plate to a suitable depth, for example about 20 microns. For embodiment, such as shown in FIG. 2, in which the rings blend into one another, preferably the blending is achieved by using a laser to produce the pattern in the metal plate, which laser is capable of etching complex slopes into the plate. Lasers suitable for such uses are commercially available. A colorant containing a binding polymer, solvent, and pigment or dye is then deposited onto the elements to fill the depressions with colorant. A silicon pad of a geometry suitable for use in printing on the surface and varying hardness, generally about 1 to about 10, is pressed against the image on the plate to remove the colorant and the colorant is then dried slightly by evaporation of the solvent. The pad is then pressed against the molding surface of an optical mold. The mold is degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

In a preferred embodiment, a clear, pre-polymer layer is used, which pre-polymer layer overlays at least the limbal ring and dot patterns and preferably forms the entirety of the lens' outermost surface. The pre-polymer may be any polymer that is capable of dispersing the pigment and any opacifying agent used.

The invention may be used to provide tinted hard or soft contact lenses made of any known lens-forming material, or material suitable for manufacturing such lenses. Preferably, the lenses of the invention are soft contact lenses the material selected for forming the lenses of the invention being any material suitable for producing soft contact lenses. Suitable preferred materials for forming soft contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the lens material contains a siloxane functionality, including, without limitation, polydimethyl siloxane macromers, methacryloxypropyl polyalkyl siloxanes, and mixtures thereof, a silicone hydrogel or a hydrogel, made of monomers containing hydroxy groups, carboxyl groups, or combinations thereof. Materials for making soft contact lenses are well known and commercially available. Preferably, the material is acquafilcon, etafilcon, genfilcon, lenefilcon, balafilcon, lotrafilcon, or galyfilcon.

What is claimed is:

1. A contact lens, comprising a gradient ring pattern.

2. The contact lens, further comprising a limbal ring.

3. The lens of claim 1, wherein the gradient ring pattern comprises about 3 to about 6 rings.

4. The lens of claim 2, wherein the gradient ring pattern comprises about 3 to about 6 rings.

5. The lens of claim 1, wherein each of the rings of the gradient ring pattern is of a width of about 0.1 to about 2 mm.

6. The lens of claim 2, wherein each of the rings of the gradient ring pattern is of a width of about 0.1 to about 2 mm.

7. The lens of claim 1, further comprising dots, lines, fanciful structures, and combinations.

8. The lens of claim 2, further comprising dots, lines, fanciful structures, and combinations.

9. The lens of claim 1, wherein the gradient ring pattern comprises an innermost border of about 4 to about 8 mm.

10. The lens of claim 2, wherein the gradient ring pattern comprises an innermost border of about 4 to about 8 mm.

11. A method of enhancing an iris, comprising providing a contact lens comprising a gradient ring.
